(19) United States
(12) Patent Application Publication
(10) Pub. No.: US 2023/0097850 A1
(43) Pub. Date: Mar. 30, 2023

(54) INTRA BLOCK COPY USING NON-ADJACENT NEIGHBORING BLOCKS

(71) Applicant: Beijing Bytedance Network Technology Co., Ltd., Beijing (CN)

(72) Inventors: Hongbin Liu, Beijing (CN); Yue Wang, Beijing (CN)

(21) Appl. No.: 18/074,898

(22) Filed: Dec. 5, 2022

Related U.S. Application Data
(63) Continuation of application No. PCT/CN2021/098526, filed on Jun. 7, 2021.

(30) Foreign Application Priority Data
Jun. 5, 2020 (CN) PCT/CN2020/094716

(51) Int. Cl. H04N 19/105; H04N 19/132; H04N 19/176

(52) U.S. Cl. CPC H04N 19/105; H04N 19/132; H04N 19/176

(57) ABSTRACT

Methods, systems and devices for intra block copy (IBC) using non-adjacent neighboring blocks are described. An example method of video processing includes inserting, for a conversion between a current video block of a video and a bitstream of the video, one or more block vectors corresponding to one or more non-adjacent neighboring blocks of the current video block into a list of motion candidates for the current video block, wherein the inserting is based on a rule that specifies an order in which the one or more non-adjacent neighboring blocks are checked for motion candidates, and performing, based on the list of motion candidates, the conversion.

### CROSS-REFERENCE TO RELATED APPLICATION

This application is a continuation of International Patent Application No. PCT/CN2021/098526, filed on Jun. 7, 2021, which claims the priority to and benefits of International Patent Application No. PCT/CN2020/094716 filed Jun. 5, 2020. All the aforementioned patent applications are hereby incorporated by reference in their entireties.

### TECHNICAL FIELD

This patent document relates to image and video coding and decoding.

### BACKGROUND

Digital video accounts for the largest bandwidth use on the internet and other digital communication networks. As the number of connected user devices capable of receiving and displaying video increases, it is expected that the bandwidth demand for digital video usage will continue to grow.

### SUMMARY

The present document discloses techniques for intra block copy (IBC) using non-adjacent neighboring blocks that can be used by image and video encoders and decoders to perform image or video encoding, decoding, or processing.

In one example aspect, a video processing method is disclosed. The method includes inserting, for a conversion between a current video block of a video and a bitstream of the video, one or more block vectors corresponding to one or more non-adjacent neighboring blocks of the current video block into a list of motion candidates for the current video block, wherein the inserting is based on a rule that specifies an order in which the one or more non-adjacent neighboring blocks are checked for motion candidates, and performing, based on the list of motion candidates, the conversion.

In another example aspect, another video processing method is disclosed. The method includes inserting, for a conversion between a current video block of a video and a bitstream of the video, one or more block vectors corresponding to one or more non-adjacent neighboring blocks of the current video block into a list of motion candidates for the current video block, wherein the inserting is based on an availability of block vectors from (i) a list of history-based block vector prediction (HBVP) candidates or (ii) adjacent neighboring blocks of the current video block, and performing, based on the list of motion candidates, the conversion.

In yet another example aspect, another video processing method is disclosed. The method includes determining, for a conversion between a current video block of a video and a bitstream of the video, that a range of a block vector component in a one-dimensional block vector search is based on a property of the current video block, and performing, based on the determining, the conversion.

In yet another example aspect, a video encoder apparatus is disclosed. The video encoder comprises a processor configured to implement above-described methods.

In yet another example aspect, a video decoder apparatus is disclosed. The video decoder comprises a processor configured to implement above-described methods.

In yet another example aspect, a computer readable medium having code stored thereon is disclose. The code embodies one of the methods described herein in the form of processor-executable code.

These, and other, features are described throughout the present document.

### BRIEF DESCRIPTION OF DRAWINGS

FIG. 1 shows an example of intra block copy (IBC).

FIG. 2 shows example positions of spatial merge candidates.

FIG. 3 shows an example of non-adjacent neighboring blocks.

FIG. 4 shows another example of non-adjacent neighboring blocks.

FIG. 5 is a block diagram showing an example video processing system in which various techniques disclosed herein may be implemented.

FIG. 6 is a block diagram of an example hardware platform used for video processing.

FIG. 7 is a block diagram that illustrates an example video coding system that can implement some embodiments of the present disclosure.

FIG. 8 is a block diagram that illustrates an example of an encoder that can implement some embodiments of the present disclosure.

FIG. 9 is a block diagram that illustrates an example of a decoder that can implement some embodiments of the present disclosure.

FIGS. 10-12 show flowcharts for example methods of video processing.

### DETAILED DESCRIPTION

Section headings are used in the present document for ease of understanding and do not limit the applicability of techniques and embodiments disclosed in each section only to that section. Furthermore, H.266 terminology is used in some description only for ease of understanding and not for limiting scope of the disclosed techniques. As such, the techniques described herein are applicable to other video codec protocols and designs also.

### 1 Introduction

The techniques described in this document may be used for encoding and decoding visual media data such as images or a video, generally called video in the present document. Specifically, it is related to intra block copy in video coding. It may be applied to the existing video coding standard like HEVC, or the standard (Versatile Video Coding, Audio Video Standard 3) to be finalized. It may be also applicable to future video coding standards or video codec.

### 2 Initial Discussion

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, Joint Video Exploration Team (JVET) was founded by VCEG and MPEG jointly in 2015. Since then, many new methods have been adopted by JVET and put into the reference software named Joint Exploration Model (JEM). In April 2018, the Joint Video Expert Team (JVET) between VCEG (Q6/16) and ISO/IEC JTC1 SC29/WG11 (MPEG) was created to work on the VVC standard targeting at 50% bitrate reduction compared to HEVC.

The latest version of VVC draft, i.e., Versatile Video Coding (Draft 9) could be found at:

http://phenix.it-sudparis.eu/jvet/doc_end_user/documents/18_Alpbach/wg11/JVET-R2001-v10.zip

The latest reference software of VVC, named VTM, could be found at:

https://vcgit.hhi.fraunhofer.de/jvet/VVCSoftware_VTM/tagsNTM-9.0

### 2.1 History-Based Merge Candidates Derivation

The history-based MVP (HMVP) merge candidates are added to merge list after the spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.

The HMVP table size S is set to be 6, which indicates up to 6 History-based MVP (HMVP) candidates may be added to the table. When inserting a new motion candidate to the table, a constrained first-in-first-out (FIFO) rule is utilized wherein redundancy check is firstly applied to find whether there is an identical HMVP in the table. If found, the identical HMVP is removed from the table and all the HMVP candidates afterwards are moved forward,

HMVP candidates could be used in the merge candidate list construction process. The latest several HMVP candidates in the table are checked in order and inserted to the candidate list after the TMVP candidate. Redundancy check is applied on the HMVP candidates to the spatial or temporal merge candidate.

To reduce the number of redundancy check operations, the following simplifications are introduced:
1) Number of HMPV candidates is used for merge list generation is set as (N<=4)? M: (8−N), wherein N indicates number of existing candidates in the merge list and M indicates number of available HMVP candidates in the table.
2) Once the total number of available merge candidates reaches the maximally allowed merge candidates minus 1, the merge candidate list construction process from HMVP is terminated.

The idea of HMVP is also extended to block vector prediction in Intra Block Copy (mode).

### 2.2 Intra Block Copy

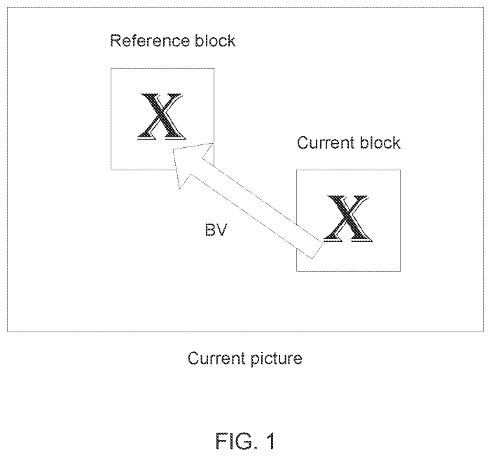

Intra block copy (IBC), a.k.a. current picture referencing, has been adopted in HEVC Screen Content Coding extensions (HEVC-SCC) and the current VVC test model (VTM-4.0). IBC extends the concept of motion compensation from inter-frame coding to intra-frame coding. As depicted in FIG. 1, the current block is predicted by a reference block in the same picture when IBC is applied. The samples in the reference block must have been already reconstructed before the current block is coded or decoded. Although IBC is not so efficient for most camera-captured sequences, it shows significant coding gains for screen content. The reason is that there are lots of repeating patterns, such as icons and text characters in a screen content picture. IBC can remove the redundancy between these repeating patterns effectively. In HEVC-SCC, an inter-coded coding unit (CU) can apply IBC if it chooses the current picture as its reference picture. The MV is renamed as block vector (BV) in this case, and a BV always has an integer-pixel precision. To be compatible with main profile HEVC, the current picture is marked as a “long-term” reference picture in the Decoded Picture Buffer (DPB). It should be noted that similarly, in multiple view/3D video coding standards, the inter-view reference picture is also marked as a “long-term” reference picture.

Following a BV to find its reference block, the prediction can be generated by copying the reference block. The residual can be got by subtracting the reference pixels from the original signals. Then transform and quantization can be applied as in other coding modes.

However, when a reference block is outside of the picture, or overlaps with the current block, or outside of the reconstructed area, or outside of the valid area restricted by some constrains, part or all pixel values are not defined. Basically, there are two solutions to handle such a problem. One is to disallow such a situation, e.g. in bitstream conformance. The other is to apply padding for those undefined pixel values. The following sub-sessions describe the solutions in detail.

### 2.3 IBC in HEVC Screen Content Coding Extensions

In the screen content coding extensions of HEVC, when a block uses current picture as reference, it should guarantee that the whole reference block is within the available reconstructed area, as indicated in the following spec text:

The variables offsetX and offsetY are derived as follows:

| | |
|---|---|
| offsetX = ( ChromaArrayType = = 0 ) ? 0 : ( mvCLX[ 0 ] & 0x7 ? 2 : 0 ) | (8-104) |
| offsetY = ( ChromaArrayType = = 0 ) ? 0 : ( mvCLX[ 1 ] & 0x7 ? 2 : 0 ) | (8-105) |

It is a requirement of bitstream conformance that when the reference picture is the current picture, the luma motion vector mvLX shall obey the following constraints:
When the derivation process for z-scan order block availability as specified in clause 6.4.1 is invoked with (xCurr, yCurr) set equal to (xCb, yCb) and the neighbouring luma location (xNbY, yNbY) set equal to (xPb+(mvLX[0]>>2)−offsetX, yPb+(mvLX[1]>>2)−offsetY) as inputs, the output shall be equal to TRUE.
When the derivation process for z-scan order block availability as specified in clause 6.4.1 is invoked with (xCurr, yCurr) set equal to (xCb, yCb) and the neighbouring luma location (xNbY, yNbY) set equal to (xPb+(mvLX[0]>>2)+nPbW−1+offsetX, yPb+(mvLX[1]>>2)+nPbH−1+offsetY) as inputs, the output shall be equal to TRUE.
One or both the following conditions shall be true:

| | |
|---|---|
| — | The value of ( mvLX[ 0 ] >> 2 ) + nPbW + xB1 + offsetX is less than or equal to 0. |
| — | The value of ( mvLX[ 1 ] >> 2 ) + nPbH + yB1 + offsetY is less than or equal to 0. |

The following condition shall be true:

```
( xPb + ( mvLX[ 0 ] >> 2 ) + nPbSw − 1 + offsetX) / CtbSizeY − xCurr / CtbSizeY <=
  yCurr/CtbSizeY − ( yPb + ( mvLX[ 1 ] >> 2 ) + nPbSh − 1 + offsetY ) / CtbSizeY
  (8-106)
```

Thus, the case that the reference block overlaps with the current block or the reference block is outside of the picture will not happen. There is no need to pad the reference or prediction block.

### 2.4 IBC in VVC Test Model

In the current VVC test model, i.e. VTM-4.0 design, the whole reference block should be with the current coding tree unit (CTU) and does not overlap with the current block. Thus, there is no need to pad the reference or prediction block. The IBC flag is coded as a prediction mode of the current CU. Thus, there are totally three prediction modes, MODE_INTRA, MODE_INTER and MODE_IBC for each CU.

### 2.4.1 IBC Merge Mode

In IBC merge mode, an index pointing to an entry in the IBC merge candidates list is parsed from the bitstream. The construction of the IBC merge list can be summarized according to the following sequence of steps:

Step 1: Derivation of spatial candidates

Step 2: Insertion of HBVP (History-based Block Vector Prediction) candidates

Step 3: Insertion of pairwise average candidates

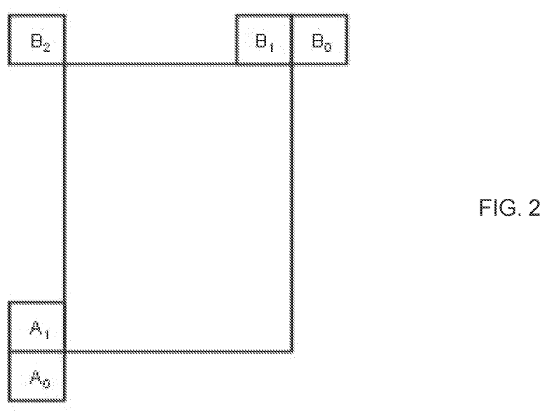

In the derivation of spatial merge candidates, a maximum of four merge candidates are selected among candidates located in the positions depicted in FIG. 2. The order of derivation is A₁, B₁, B₀, A₀ and B₂. Position B₂ is considered only when any PU of position A₁, B₁, B₀, A₀ is not available (e.g. because it belongs to another slice or tile) or is not coded with IBC mode. After candidate at position A₁ is added, the insertion of the remaining candidates is subject to a redundancy check which ensures that candidates with same motion information are excluded from the list so that coding efficiency is improved. To reduce computational complexity, not all possible candidate pairs are considered in the mentioned redundancy check. Instead only the pairs linked with an arrow in FIG. 2 are considered and a candidate is only added to the list if the corresponding candidate used for redundancy check has not the same motion information.

After insertion of the spatial candidates, if the IBC merge list size is still smaller than the maximum IBC merge list size, IBC candidates from HBVP table may be inserted. Redundancy check are performed when inserting the HBVP candidates.

Finally, pairwise average candidates are inserted into the IBC merge list.

When a reference block identified by a merge candidate is outside of the picture, or overlaps with the current block, or outside of the reconstructed area, or outside of the valid area restricted by some constrains, the merge candidate is called invalid merge candidate.

It is noted that invalid merge candidates may be inserted into the IBC merge list.

### 2.4.2 IBC AMVP Mode

In IBC AMVP (Advanced Motion Vector Prediction) mode, an AMVP index point to an entry in the IBC AMVP list is parsed from the bitstream. The construction of the IBC AMVP list can be summarized according to the following sequence of steps:

Step 1: Derivation of spatial candidates
Check A₀, A₁ until an available candidate is found.
Check B₀, B₁, B₂ until an available candidate is found.

Step 2: Insertion of HBVP candidates.

Step 3: Insertion of zero candidates.

After insertion of the spatial candidates, if the IBC AMVP list size is still smaller than the maximum IBC AMVP list size, IBC candidates from HBVP table may be inserted.

Finally, zero candidates are inserted into the IBC AMVP list.

### 2.5 IBC AMVP Mode in AVS3

In AVS3 (Audio Video coding Standard 3), a HBVP list is maintained to store BVs of previously coded blocks. For each entry of the HBVP list, besides a BV, information of the block associated with the BV, including width and height of the block and the coordinates of the top-left sample of the block (relative to the top-left sample of the picture), is also stored. Meanwhile, a counter indicating how many times the BV is encountered is also stored in the entry. Hereinafter, coordinate of the top-left sample of the block is also used as the coordinates of the block.

In the IBC AMVP mode, when constructing the IBC AMVP (Advanced Motion Vector Prediction) list for a current block, first, BVs in the HBVP list are checked in order and classified into 7 classes. Each class can contain at most one BV, if more than one BVs are classified into one same class, the latest checked one is used for the class.
For a BV, if the size (e.g., width*height) of the block associated with the BV is greater than or equal to 64, it is placed into the 0^{th} class.
For a BV, if its counter is greater than or equal to 3, it is placed into the 1^{st} class.
For a BV, it is further classified in the following order:
   if its horizontal coordinator is less than the horizontal coordinator of the current block and its vertical coordinator is less than the vertical coordinator of the current block, it is placed into the 4^{th} class, e.g. the above-left class.
   else if its horizontal coordinate is greater than or equal to the horizontal coordinate of the current block plus the width of the current block, it is placed into the 5^{th} class, e.g., the above-right class.
   else if its vertical coordinate is greater than or equal to the vertical coordinate of the current block plus the height of the current block, it is placed into the 6^{th} class, e.g., the below-left class.
   else if its vertical coordinate is less than the vertical coordinate of the current block, it is placed into the 3^{rd} class, e.g., the above class.
   else if its horizontal coordinate is less than the horizontal coordinate of the current block, it is placed into the 2^{nd} class, e.g., the left class.

Second, BVs of classes 0-6 are inserted into the AMVP list in order. If a class is not empty, the corresponding BV may be added to the AMVP list after pruned with already inserted AMVP candidates.

In the BV estimation process, an initial BV is first determined. Then, one-dimensional vertical BV search, one-dimensional horizontal BV search and two-dimensional BV search are performed successfully to find the best BV. Each BV search stage starts from the same initial BV. In the one-dimensional vertical BV search, the vertical BV component is constrained to be less than or equal to y−H. Similarly, in the one-dimensional horizontal BV search, the horizontal BV component is constrained to be less than or equal to x−W.

### 3 Technical Problems Solved by Disclosed Technical Solutions

1. Block vector (BV) of non-adjacent neighboring blocks are not used when constructing the IBC merge list or AMVP list, which is inefficient.
2. In AVS3, when classifying a BV from the HBVP list, the block size (e.g., width*height of a block) associated with the BV is compared with a fixed value (e.g., 64) to decide whether the BV shall be classified into the 0^{th} class, regardless the size of the current block, which may be unreasonable.
3. In AVS3, in the one-dimensional BV search stage, a very strict constraint is applied to the vertical BV component and the horizontal BV component, which is inefficient.

### 4 Example Solutions and Embodiments

The items below should be considered as examples to explain general concepts. These items should not be interpreted in a narrow way. Furthermore, these items can be combined in any manner.

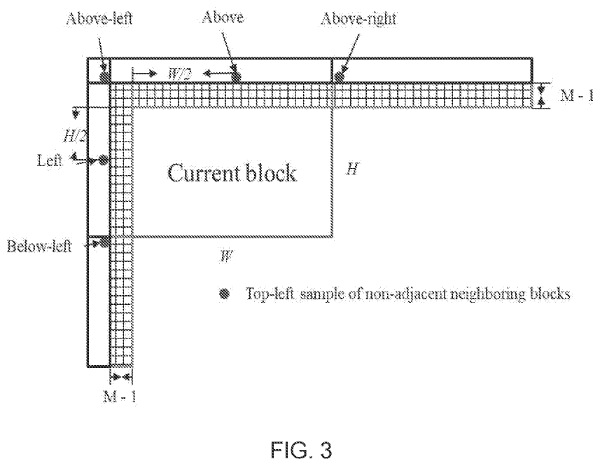

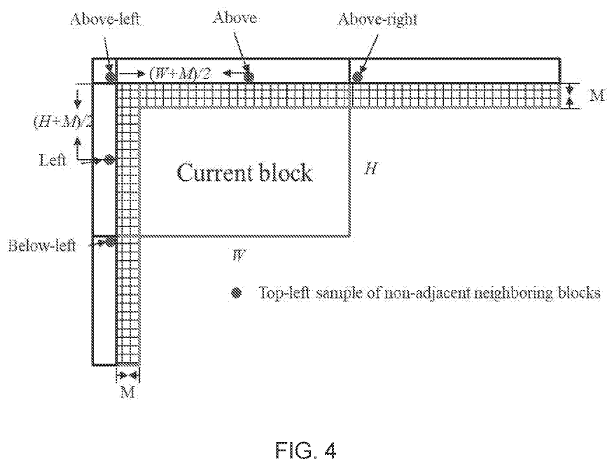

Denote coordinate of the current block (e.g., coordinate of the top-left sample of the block) as (x, y) and denote width and height of the current block as W and H, respectively. Denote coordinate of a non-adjacent neighboring sample as (x−deltaX, y−deltaY), wherein deltaX and deltaY are positive integers, negative integers or 0, and a non-adjacent neighboring block is the S1*S2 (S1 and Se are integers, e.g., S1=S2=4) block covering the sample.
1. It is proposed that BVs of non-adjacent neighboring blocks may be inserted into the IBC merge list or/and the IBC AMVP list.
   a. In one example, positions of non-adjacent neighboring blocks may depend on width or/and height of the current block.
      i. For example, non-adjacent neighboring blocks covering positions (x−M, y−M), (x−M, y+H/2), (x−M, y+H), (x+W/2, y−M), (x+W, y−M) may be checked when constructing the IBC merge list or/and the IBC AMVP list, wherein M is an integer, as illustrated in FIG. 3. For example, M=8.
         1. Alternatively, non-adjacent neighboring blocks covering positions (x M, y−M), (x−M, y+H−1), (x−M, y+H), (x+W−1, y−M), (x+W, y−M) may be checked when constructing the IBC merge list or/and the IBC AMVP list.
         2. Alternatively, furthermore, non-adjacent neighboring blocks covering positions (x−M, y), (x, y−M), (x−M, y+3*H/2), (x−M, y+2*H), (x+3*W/2, y−M), (x+2*W, y−M) may be checked when constructing the IBC merge list or/and the IBC AMVP list.
      ii. For example, non-adjacent neighboring blocks covering positions (x−M−1, y−M−1), (x−M−1, y−M−1+(H+M)/2), (x−M−1, y+H), (x−M−1+(W+M)/2, y−M−1), (x+W, y−M−1) may be checked when constructing the IBC merge list or/and the IBC AMVP list, wherein M is an integer, as illustrated in FIG. 4. For example, M=8.
         1. Alternatively, non-adjacent neighboring blocks covering positions (x−M−1, y−M−1), (x−M−1,y+H−1), (x−M−1, y+H), (x+W−1, y−M−1), (x+W, y−M−1) may be checked when constructing the IBC merge list or/and the IBC AMVP list.
         2. Alternatively, furthermore, non-adjacent neighboring blocks covering positions (x−M−1, y), (x, y−M−1), (x−M−1, y−M−1+3*(H+M)/2), (x−M−1, y+2*H+M), (x−M−1+3*(W+M)/2, y−M−1), (x2*W+M, y−M−1) may be checked when constructing the IBC merge list or/and the IBC AMVP list.
   b. In one example, how many non-adjacent neighboring blocks are checked may depend on the shape or dimension of the current block.
   c. In one example, how many non-adjacent neighboring blocks are checked may depend on the coordinate of the current block.
2. It is proposed that checking order of the non-adjacent neighboring blocks may depend on the relative positions of the neighboring blocks to the current block.
   a. In one example, checking order of the non-adjacent neighboring blocks may be as follows: above-left neighboring block, above-right neighboring block, below-left neighboring block, above neighboring block, and the left neighboring block of the current block.
      i. For example, non-adjacent neighboring blocks covering positions (x−M, y (x−M, y+H/2), (x−M, y+H), (x+W/2, y−M), (x+W, y−M) are checked in the order of: (x−M, y−M), (x+W, y−M), (x−M, y+H), (x+W/2, y−M), (x−M, y+H/2).
      ii. For example, non-adjacent neighboring blocks covering positions (x−M−1, y−M−1), (x−M−1, y−M+(H+M)/2), (x−M−1, y+H), (x−M+(W+M)/2, y−M−1), (x+W,y−M−1) are checked in the order of: (x−M−1, y−M−1), (x+W, y−M−1), (x−M−1,y+H), (x−M+(W+M)/2, y−M−1), (x−M−1,y−M+(H+M)/2).
   b. In one example, checking order of the non-adjacent neighboring blocks may be as follows: left neighboring block, above neighboring block, above-left neighboring block, above-right neighboring block and below-left neighboring block of the current block.
      i. For example, non-adjacent neighboring blocks covering positions (x−M, y−M), (x−M, y+H/2), (x−M, y+H), (x+W/2, y−M), (x+W, y−M) are checked in the order of: (x−M, y+H/2), (x+W/2, y (x−M, y (x+W, y−M), (x−M, y+H).
      ii. For example, non-adjacent neighboring blocks covering positions (x−M−1, y−M−1), (x−M−1, y−M+(H+M)/2), (x−M−1, y+H), (x−M+(W+M)/2, y−M−1), (x+W,y−M−1) are checked in the order of: (x−M−1, y−M+(H+M)/2), (x−M+(W+M)/2, y−M−1), (x−M−1, y−M−1), (x+W, y−M−1), (x−M−1, y+H).
   c. In one example, checking order of the non-adjacent neighboring blocks may be as follows: left neighboring block, above neighboring block, above-right neighboring block, below-left neighboring block, and the above-left neighboring block of the current block.
   d. In one example, checking order of the non-adjacent neighboring blocks may be as follows: below-left neighboring block, left neighboring block, above-right neighboring block, above neighboring block, and the above-left neighboring block of the current block.
   e. In one example, checking order of the non-adjacent neighboring blocks may be as follows: above-left neighboring block, left neighboring block, above neighboring block, above-right neighboring block and below-left neighboring block of the current block.
   f. In one example, checking order of the non-adjacent neighboring blocks may be as follows: above-left neighboring block, above neighboring block, left neighboring block, above-right neighboring block and below-left neighboring block of the current block.
   g. In one example, checking order of the non-adjacent neighboring blocks may be as follows: above neighboring block, left neighboring block, above-left neighboring block, above-right neighboring block and below-left neighboring block of the current block.
   h. In one example, the non-adjacent neighboring blocks may be classified into multiple groups, candidates in each group are checked in a predefined order and at most N (N is an integer, e.g., N=1) candidates from one group may be inserted into the IBC merge list or/and IBC AMVP list.
      i. For example, the non-adjacent neighboring blocks may be classified into two groups: {below-left, left}-neighboring blocks, {above-right, above, above-left}-neighboring blocks.
      ii. For example, the non-adjacent neighboring blocks may be classified into two groups: {below-left, left, above-left}-neighboring blocks, {above-right, above}-neighboring blocks.
   i. In one example, checking order of the non-adjacent neighboring blocks may depend on the distance from the neighboring block to the current block.
      i. For example, the distance may be defined as the distance from the top-left sample of the neighboring block to the top-left sample of the current block.
         1. The distance may be defined as the sum of the horizontal distance and the vertical distance from the top-left sample of the neighboring block to the top-left sample of the current block.
         2. The distance may be defined as sum of the squared horizontal distance and the squared vertical distance from the top-left sample of the neighboring block to the top-left sample of the current block.
      ii. For example, the non-adjacent neighboring blocks may be checked in ascending distance order.
      iii. For example, the non-adjacent neighboring blocks may be checked in descending distance order.
   j. In one example, checking order of the non-adjacent neighboring blocks may depend on the dimension or shape of the current block.
      i. For example, for a block with W>M1*H (e.g., M1=2), above, above-right, and above-left neighboring blocks may be given a higher priority than the below-left and left neighboring blocks.
      ii. For example, for a block with W>M1*H (e.g., M1=2), above, above-right, and above-left neighboring blocks may be given a lower priority than the below-left and left neighboring blocks.
      iii. For example, for a block with H>M1*W (e.g., M1=2), above, above-right, and above-left neighboring blocks may be given a higher priority than the below-left and left neighboring blocks.
      iv. For example, for a block with H>M1*W (e.g., M1=2), above, above-right, and above-left neighboring blocks may be given a lower priority than the below-left and left neighboring blocks.
   k. In one example, checking order of the non-adjacent neighboring blocks may depend on the dimension of the neighboring blocks.
      i. For example, the non-adjacent neighboring blocks may be checked in ascending size (width*height) order.
      ii. For example, the non-adjacent neighboring blocks may be checked in descending size (width*height) order.
3. It is proposed that insertion of BVs of the non-adjacent neighboring blocks into the IBC merge list or/and IBC AMVP list may depend on the availability of BVs from the HBVP list or/and availability of BVs of the adjacent neighboring blocks.
   a. In one example, BVs of the non-adjacent neighboring blocks are inserted after BVs from the HBVP list.
      i. Alternatively, BVs of the non-adjacent neighboring blocks are inserted before BVs from the HBVP list.
      ii. Alternatively, BVs of the non-adjacent neighboring blocks are interleaved with BVs from the HBVP list.
   b. In one example, BVs of the non-adjacent neighboring blocks are inserted after BVs of the adjacent neighboring blocks.
      i. Alternatively, BVs of the non-adjacent neighboring blocks are inserted before BVs of the adjacent neighboring blocks.
      ii. Alternatively, BVs of the non-adjacent neighboring blocks are interleaved with BVs of the adjacent neighboring blocks.
   c. In one example, no BVs of the non-adjacent neighboring blocks are inserted when there are no empty entries in the IBC merge/AMVP list after inserting BVs from the HBVP list or/and BVs of the adjacent neighboring blocks.
   d. In one example, BVs of the non-adjacent neighboring blocks may be classified into multiple classes in a similar way with BVs from the HBVP list.
      i. For example, non-adjacent neighboring blocks may be classified into 5 classes according to the relative positions of the neighboring blocks to the current block, including the above-left class, above-right class, below-left class, above class and left class. One or multiple non-adjacent neighboring blocks may be classified into one class.
      ii. In one example, when the HBVP list does not contain any available BV in a first class, BV of a non-adjacent neighboring block belonging to the first class (if available) may be used instead.
         1. In one example, BVs of one or multiple non-adjacent neighboring blocks belonging to the first class may be checked in a predefined order until an available BV is found or all BVs are checked.
         2. BVs of one or multiple non-adjacent neighboring blocks belonging to the first class may be checked in a predefined order until an BV in the first class is inserted into the IBC merge/AMVP list or all BVs are checked.
      iii. In one example, when there are available BVs from both the HBVP list and the non-adjacent neighboring blocks for a first class, which BV is used may depend on the distances (similar as defined in bullet 2.e) from the blocks associated with the BVs to the current block.
         1. For example, BVs may be checked in descending distance order until an available BV is found, or all BVs are checked.
         2. For example, BVs may be checked in descending distance order until an BV is inserted into the IBC merge/AMVP list or all BVs are checked.
         3. For example, BVs may be checked in ascending distance order until an available BV is found, or all BVs are checked.
         4. For example, BVs may be checked in ascending distance order until an BV is inserted into the IBC merge/AMVP list or all BVs are checked.
   e. In one example, when the HBVP list does not contain any available BV in a first class (e.g., the first class may be one of the 0^{th}, 1^{st}, 2^{nd}, 3^{rd}, 4^{th}, 5^{th} or 6^{th} class), BVs of a non-adjacent neighboring block may be used for the first class.
      i. In one example, when the HBVP list does not contain any available BV in a first class, BVs of a first set of non-adjacent neighboring blocks may be checked in order until an available BV is found, or all BVs are checked.
      ii. In one example, when the HBVP list does not contain any available BV in a second class, BVs of a second set of non-adjacent neighboring blocks may be checked in order until an available BV is found. The first set of non-adjacent neighboring blocks may be different from the second set of non-adjacent neighboring blocks when the first class is different from the second class.
         1. Alternatively, the first set of non-adjacent neighboring blocks may be same with the second set of non-adjacent neighboring blocks.
      iii. In one example, if a non-adjacent neighboring block belongs to a first non-adjacent neighboring block set, it may not belong to a second non-adjacent neighboring block set which is different from the first non-adjacent neighboring block set.
      iv. In one example, when BV of a first non-adjacent neighboring block is used for a first class, it may not be checked again for a second class.
         1. Alternatively, when BV of a first non-adjacent neighboring block is checked for a first class, it may not be checked again for a second class.
   f. In one example, before insertion of a BV from a non-adjacent neighboring block, the BV may be compared to one or multiple BVs that are already inserted into the IBC merge/AMVP list.
      i. In one example, if a BV from a non-adjacent neighboring block is identical to one of the one or multiple BVs that are already inserted into the IBC merge/AMVP list, it is not inserted into the IBC merge/AMVP list.
      ii. In one example, if a BV from a non-adjacent neighboring block is similar to one of the one or multiple BVs that are already inserted into the IBC merge/AMVP list, it is not inserted into the IBC merge/AMVP list.
      iii. In one example, such comparison may be performed for one or multiple BVs from the non-adjacent neighboring blocks.
      iv. Alternatively, no comparison is performed.
4. It is proposed that whether a BV from the HBVP list shall be classified into the Nth (N is a non-negative integer, e.g., N=0) class may be decided according to the block size associated with the BV (denoted as BvBlkSize) and the size of the current block (denoted as CurBlkSize).
   a. In one example, when BvBlkSize is greater than or equal to factor*CurBlkSize, the BV may be classified into the Nth class, wherein the factor is a positive number. For example, factor is equal to 1.
   b. In one example, when BvBlkSize is greater than factor*CurBlkSize, the BV may be classified into the Nth class, wherein the factor is a positive number. For example, factor is equal to 1.
   c. In one example, when BvBlkSize is less than or equal factor*CurBlkSize, the BV may be classified into the Nth class, wherein the factor is a positive number. For example, factor is equal to 1.
   d. In one example, when BvBlkSize is less than factor*CurBlkSize, the BV may be classified into the Nth class, wherein the factor is a positive number. For example, factor is equal to 1.
   e. In one example, when BvBlkSize is equal to factor*CurBlkSize, the BV may be classified into the Nth class, wherein the factor is a positive number. For example, factor is equal to 1.
   f. Alternatively, whether a BV from the HBVP list shall be classified into the Nth class may be decided according to the block dimension associated with the BV and the dimension of the current block.
5. It is proposed that the range of the BV component in the one-dimensional BV search may only depend on the coordinate of the current block.
   a. Alternatively, furthermore, the range of the BV component in the one-dimensional BV search may not depend on the dimension of the current block.
   b. In one example, in the one-dimensional vertical BV search, the vertical BV component is constrained to be less than or equal to y−N1 (N1 is an integer, e.g., N1=0, 8 or −8).
   c. In one example, in the one-dimensional horizontal BV search, the horizontal BV component is constrained to be less than or equal to x−N2 (N2 is an integer, e.g., N2=0, 8 or −8).
   d. Alternatively, the range of the BV component in the one-dimensional BV search may depend on both the dimension and the coordinate of the current block.
      i. For example, in the one-dimensional vertical BV search, the vertical BV component is constrained to be less than or equal to y+H−N1 (N1 is an integer, e.g., N1=0, 8 or −8).
      ii. For example, in the one-dimensional horizontal BV search, the horizontal BV component is constrained to be less than or equal to x+W−N2 (N2 is an integer, e.g., N2=0, 8 or −8).

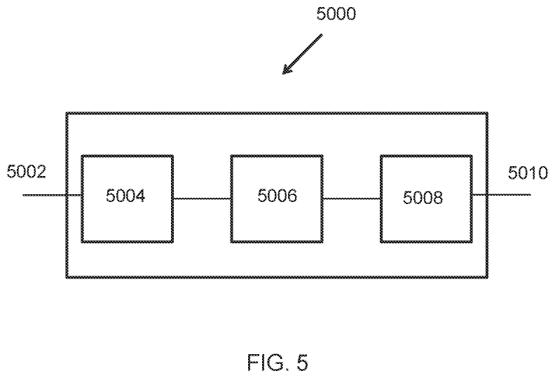

FIG. 5 is a block diagram showing an example video processing system 5000 in which various techniques disclosed herein may be implemented. Various implementations may include some or all of the components of the system 5000. The system 5000 may include input 5002 for receiving video content. The video content may be received in a raw or uncompressed format, e.g., 8 or 10 bit multi-component pixel values, or may be in a compressed or encoded format. The input 5002 may represent a network interface, a peripheral bus interface, or a storage interface. Examples of network interface include wired interfaces such as Ethernet, passive optical network (PON), etc. and wireless interfaces such as Wi-Fi or cellular interfaces.

The system 5000 may include a coding component 5004 that may implement the various coding or encoding methods described in the present document. The coding component 5004 may reduce the average bitrate of video from the input 5002 to the output of the coding component 5004 to produce a coded representation of the video. The coding techniques are therefore sometimes called video compression or video transcoding techniques. The output of the coding component 5004 may be either stored, or transmitted via a communication connected, as represented by the component 5006. The stored or communicated bitstream (or coded) representation of the video received at the input 5002 may be used by the component 5008 for generating pixel values or displayable video that is sent to a display interface 5010. The process of generating user-viewable video from the bitstream representation is sometimes called video decompression. Furthermore, while certain video processing operations are referred to as “coding” operations or tools, it will be appreciated that the coding tools or operations are used at an encoder and corresponding decoding tools or operations that reverse the results of the coding will be performed by a decoder.

Examples of a peripheral bus interface or a display interface may include universal serial bus (USB) or high definition multimedia interface (HDMI) or Displayport, and so on. Examples of storage interfaces include SATA (serial advanced technology attachment), PCI, IDE interface, and the like. The techniques described in the present document may be embodied in various electronic devices such as mobile phones, laptops, smartphones or other devices that are capable of performing digital data processing and/or video display.

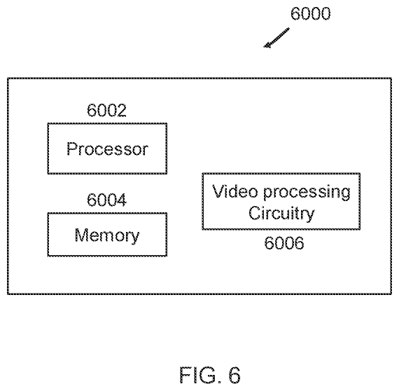

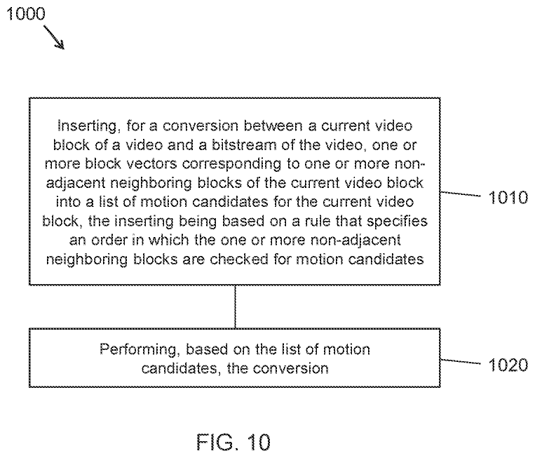

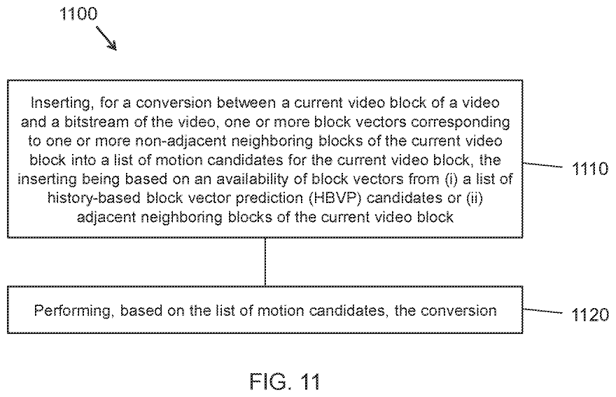

FIG. 6 is a block diagram of a video processing apparatus 6000. The apparatus 6000 may be used to implement one or more of the methods described herein. The apparatus 6000 may be embodied in a smartphone, tablet, computer, Internet of Things (IoT) receiver, and so on. The apparatus 6000 may include one or more processors 6002, one or more memories 6004 and video processing hardware 6006. The processor(s) 6002 may be configured to implement one or more methods described in the present document (e.g., in FIGS. 10-11). The memory (memories) 6004 may be used for storing data and code used for implementing the methods and techniques described herein. The video processing hardware 6006 may be used to implement, in hardware circuitry, some techniques described in the present document. In some embodiments, the hardware 6006 may be partly or entirely in the one or more processors 6002, e.g., a graphics processor.

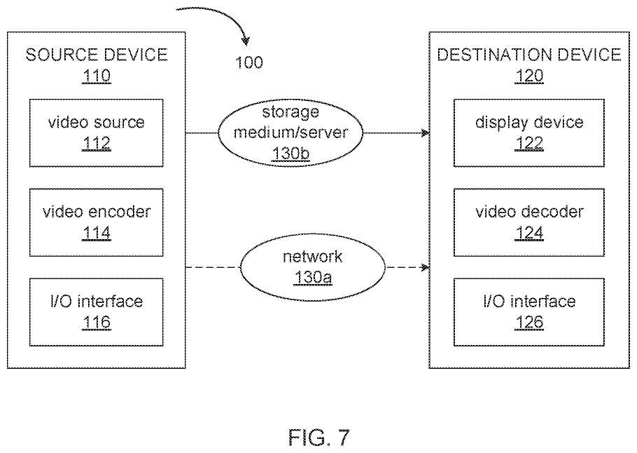

FIG. 7 is a block diagram that illustrates an example video coding system 100 that may utilize the techniques of this disclosure. As shown in FIG. 7, video coding system 100 may include a source device 110 and a destination device 120. Source device 110 generates encoded video data which may be referred to as a video encoding device. Destination device 120 may decode the encoded video data generated by source device 110 which may be referred to as a video decoding device. Source device 110 may include a video source 112, a video encoder 114, and an input/output (I/O) interface 116.

Video source 112 may include a source such as a video capture device, an interface to receive video data from a video content provider, and/or a computer graphics system for generating video data, or a combination of such sources. The video data may comprise one or more pictures. Video encoder 114 encodes the video data from video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. I/O interface 116 may include a modulator/demodulator (modem) and/or a transmitter. The encoded video data may be transmitted directly to destination device 120 via I/O interface 116 through network 130a. The encoded video data may also be stored onto a storage medium/server 130b for access by destination device 120.

Destination device 120 may include an I/O interface 126, a video decoder 124, and a display device 122.

I/O interface 126 may include a receiver and/or a modem. I/O interface 126 may acquire encoded video data from the source device 110 or the storage medium/server 130b. Video decoder 124 may decode the encoded video data. Display device 122 may display the decoded video data to a user. Display device 122 may be integrated with the destination device 120, or may be external to destination device 120 which be configured to interface with an external display device.

Video encoder 114 and video decoder 124 may operate according to a video compression standard, such as the High Efficiency Video Coding (HEVC) standard, Versatile Video Coding (VVM) standard and other current and/or further standards.

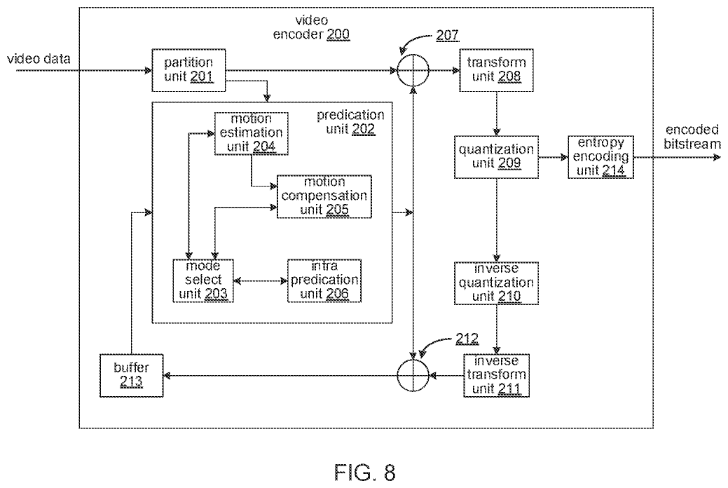

FIG. 8 is a block diagram illustrating an example of video encoder 200, which may be video encoder 114 in the system 100 illustrated in FIG. 7.

Video encoder 200 may be configured to perform any or all of the techniques of this disclosure. In the example of FIG. 8, video encoder 200 includes a plurality of functional components. The techniques described in this disclosure may be shared among the various components of video encoder 200. In some examples, a processor may be configured to perform any or all of the techniques described in this disclosure.

The functional components of video encoder 200 may include a partition unit 201, a predication unit 202 which may include a mode select unit 203, a motion estimation unit 204, a motion compensation unit 205 and an intra prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, video encoder 200 may include more, fewer, or different functional components. In an example, predication unit 202 may include an intra block copy (IBC) unit. The IBC unit may perform predication in an IBC mode in which at least one reference picture is a picture where the current video block is located.

Furthermore, some components, such as motion estimation unit 204 and motion compensation unit 205 may be highly integrated, but are represented in the example of FIG. 8 separately for purposes of explanation.

Partition unit 201 may partition a picture into one or more video blocks. Video encoder 200 and video decoder 300 may support various video block sizes.

Mode select unit 203 may select one of the coding modes, intra or inter, e.g., based on error results, and provide the resulting intra- or inter-coded block to a residual generation unit 207 to generate residual block data and to a reconstruction unit 212 to reconstruct the encoded block for use as a reference picture. In some example, Mode select unit 203 may select a combination of intra and inter predication (CIIP) mode in which the predication is based on an inter predication signal and an intra predication signal. Mode select unit 203 may also select a resolution for a motion vector (e.g., a sub-pixel or integer pixel precision) for the block in the case of inter-predication.

To perform inter prediction on a current video block, motion estimation unit 204 may generate motion information for the current video block by comparing one or more reference frames from buffer 213 to the current video block. Motion compensation unit 205 may determine a predicted video block for the current video block based on the motion information and decoded samples of pictures from buffer 213 other than the picture associated with the current video block.

Motion estimation unit 204 and motion compensation unit 205 may perform different operations for a current video block, for example, depending on whether the current video block is in an I slice, a P slice, or a B slice.

In some examples, motion estimation unit 204 may perform uni-directional prediction for the current video block, and motion estimation unit 204 may search reference pictures of list 0 or list 1 for a reference video block for the current video block. Motion estimation unit 204 may then generate a reference index that indicates the reference picture in list 0 or list 1 that contains the reference video block and a motion vector that indicates a spatial displacement between the current video block and the reference video block. Motion estimation unit 204 may output the reference index, a prediction direction indicator, and the motion vector as the motion information of the current video block. Motion compensation unit 205 may generate the predicted video block of the current block based on the reference video block indicated by the motion information of the current video block.

In other examples, motion estimation unit 204 may perform bi-directional prediction for the current video block, motion estimation unit 204 may search the reference pictures in list 0 for a reference video block for the current video block and may also search the reference pictures in list 1 for another reference video block for the current video block. Motion estimation unit 204 may then generate reference indexes that indicate the reference pictures in list 0 and list 1 containing the reference video blocks and motion vectors that indicate spatial displacements between the reference video blocks and the current video block. Motion estimation unit 204 may output the reference indexes and the motion vectors of the current video block as the motion information of the current video block. Motion compensation unit 205 may generate the predicted video block of the current video block based on the reference video blocks indicated by the motion information of the current video block.

In some examples, motion estimation unit 204 may output a full set of motion information for decoding processing of a decoder.

In some examples, motion estimation unit 204 may do not output a full set of motion information for the current video. Rather, motion estimation unit 204 may signal the motion information of the current video block with reference to the motion information of another video block. For example, motion estimation unit 204 may determine that the motion information of the current video block is sufficiently similar to the motion information of a neighboring video block.

In one example, motion estimation unit 204 may indicate, in a syntax structure associated with the current video block, a value that indicates to the video decoder 300 that the current video block has the same motion information as the another video block.

In another example, motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

Intra prediction unit 206 may perform intra prediction on the current video block. When intra prediction unit 206 performs intra prediction on the current video block, intra prediction unit 206 may generate prediction data for the current video block based on decoded samples of other video blocks in the same picture. The prediction data for the current video block may include a predicted video block and various syntax elements.

Residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and residual generation unit 207 may not perform the subtracting operation.

Transform processing unit 208 may generate one or more transform coefficient video blocks for the current video block by applying one or more transforms to a residual video block associated with the current video block.

After transform processing unit 208 generates a transform coefficient video block associated with the current video block, quantization unit 209 may quantize the transform coefficient video block associated with the current video block based on one or more quantization parameter (QP) values associated with the current video block.

Inverse quantization unit 210 and inverse transform unit 211 may apply inverse quantization and inverse transforms to the transform coefficient video block, respectively, to reconstruct a residual video block from the transform coefficient video block. Reconstruction unit 212 may add the reconstructed residual video block to corresponding samples from one or more predicted video blocks generated by the predication unit 202 to produce a reconstructed video block associated with the current block for storage in the buffer 213.

After reconstruction unit 212 reconstructs the video block, loop filtering operation may be performed reduce video blocking artifacts in the video block.

Entropy encoding unit 214 may receive data from other functional components of the video encoder 200. When entropy encoding unit 214 receives the data, entropy encoding unit 214 may perform one or more entropy encoding operations to generate entropy encoded data and output a bitstream that includes the entropy encoded data.

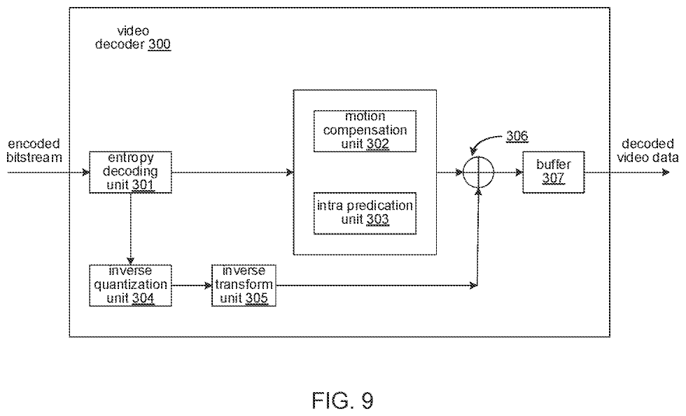

FIG. 9 is a block diagram illustrating an example of video decoder 300 which may be video decoder 114 in the system 100 illustrated in FIG. 7.

The video decoder 300 may be configured to perform any or all of the techniques of this disclosure. In the example of FIG. 9, the video decoder 300 includes a plurality of functional components. The techniques described in this disclosure may be shared among the various components of the video decoder 300. In some examples, a processor may be configured to perform any or all of the techniques described in this disclosure.

In the example of FIG. 9, video decoder 300 includes an entropy decoding unit 301, a motion compensation unit 302, an intra prediction unit 303, an inverse quantization unit 304, an inverse transformation unit 305, and a reconstruction unit 306 and a buffer 307. Video decoder 300 may, in some examples, perform a decoding pass generally reciprocal to the encoding pass described with respect to video encoder 200 (FIG. 8).

Entropy decoding unit 301 may retrieve an encoded bitstream. The encoded bitstream may include entropy coded video data (e.g., encoded blocks of video data). Entropy decoding unit 301 may decode the entropy coded video data, and from the entropy decoded video data, motion compensation unit 302 may determine motion information including motion vectors, motion vector precision, reference picture list indexes, and other motion information. Motion compensation unit 302 may, for example, determine such information by performing the AMVP and merge mode.

Motion compensation unit 302 may produce motion compensated blocks, possibly performing interpolation based on interpolation filters. Identifiers for interpolation filters to be used with sub-pixel precision may be included in the syntax elements.

Motion compensation unit 302 may use interpolation filters as used by video encoder 20 during encoding of the video block to calculate interpolated values for sub-integer pixels of a reference block. Motion compensation unit 302 may determine the interpolation filters used by video encoder 200 according to received syntax information and use the interpolation filters to produce predictive blocks.

Motion compensation unit 302 may uses some of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence.

Intra prediction unit 303 may use intra prediction modes for example received in the bitstream to form a prediction block from spatially adjacent blocks. Inverse quantization unit 303 inverse quantizes, i.e., de-quantizes, the quantized video block coefficients provided in the bitstream and decoded by entropy decoding unit 301. Inverse transform unit 303 applies an inverse transform.

Reconstruction unit 306 may sum the residual blocks with the corresponding prediction blocks generated by motion compensation unit 202 or intra-prediction unit 303 to form decoded blocks. If desired, a deblocking filter may also be applied to filter the decoded blocks in order to remove blockiness artifacts. The decoded video blocks are then stored in buffer 307, which provides reference blocks for subsequent motion compensation/intra predication and also produces decoded video for presentation on a display device.

FIGS. 10-12 show example methods that can implement the technical solution described above in, for example, the embodiments shows in FIGS. 5-9.

FIG. 10 shows a flowchart for an example method 1000 of video processing. The method 1000 includes, at operation 1010, inserting, for a conversion between a current video block of a video and a bitstream of the video, one or more block vectors corresponding to one or more non-adjacent neighboring blocks of the current video block into a list of motion candidates for the current video block, the inserting being based on a rule that specifies an order in which the one or more non-adjacent neighboring blocks are checked for motion candidates.

The method 1000 includes, at operation 1020, performing, based on the list of motion candidates, the conversion.

FIG. 11 shows a flowchart for an example method 1100 of video processing. The method 1100 includes, at operation 1110, inserting, for a conversion between a current video block of a video and a bitstream of the video, one or more block vectors corresponding to one or more non-adjacent neighboring blocks of the current video block into a list of motion candidates for the current video block, the inserting being based on an availability of block vectors from (i) a list of history-based block vector prediction (HBVP) candidates or (ii) adjacent neighboring blocks of the current video block.

The method 1100 includes, at operation 1120, performing, based on the list of motion candidates, the conversion.

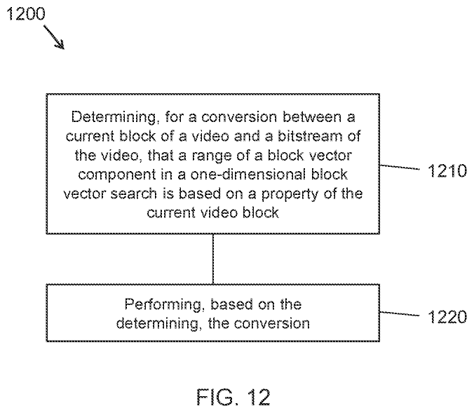

FIG. 12 shows a flowchart for an example method 1200 of video processing. The method 1200 includes, at operation 1210, determining, for a conversion between a current video block of a video and a bitstream of the video, that a range of a block vector component in a one-dimensional block vector search is based on a property of the current video block.

The method 1200 includes, at operation 1220, performing, based on the determining, the conversion.

The following solutions show example embodiments of techniques discussed in the previous section (e.g., items 1-5).

A listing of solutions preferred by some embodiments is provided next.

1. A method of video processing, comprising inserting, for a conversion between a current video block of a video and a bitstream of the video, one or more block vectors corresponding to one or more non-adjacent neighboring blocks of the current video block into a list of motion candidates for the current video block, wherein the inserting is based on a rule that specifies an order in which the one or more non-adjacent neighboring blocks are checked for motion candidates; and performing, based on the list of motion candidates, the conversion.

2. The method of solution 1, wherein the list comprises an intra block copy (IBC) merge list.

3. The method of solution 1, wherein the list comprises an intra block copy (IBC) advanced motion vector prediction (AMVP) list.

4. The method of any of solutions 1 to 3, wherein the order is based on positions of the one or more non-adjacent neighboring blocks relative to the current video block, and wherein the positions are based on a width (W) or a height (H) of the current video block.

5. The method of solution 4, wherein the one or more non-adjacent neighboring blocks that are checked when constructing the IBC merge list comprise video blocks that cover positions (x−M, y+H/2) or (x+W/2, y−M), wherein M is an integer.

6. The method of solution 5, wherein M=8.

7. The method of solution 4, wherein the one or more non-adjacent neighboring blocks that are checked when constructing the list comprises video blocks that cover positions (x−M, y−M), (x−M, y+H−1), (x−M, y+H), (x+W−1, y−M), or (x+W, y−M), and wherein M is an integer.

8. The method of solution 4, wherein the one or more non-adjacent neighboring blocks that are checked when constructing the list comprises video blocks that cover positions (x−M, y), (x, y−M), (x−M, y+3*H/2), (x−M, y+2*H), (x+3*W/2, y−M), or (x+2*W, y−M), and wherein M is an integer.

9. The method of solution 4, wherein the one or more non-adjacent neighboring blocks that are checked when constructing the list comprises video blocks that cover positions (x−M−1, y−M−1), −M−1, y−M−1+(H+M)/2), (x−M−1, y+H), (x−M−1+(W+M)/2, y−M−1), or (x+W, y−M−1), wherein M is an integer.

10. The method of any of solutions 1 to 3, wherein a number of the one or more non-adjacent neighboring blocks is based on a shape or dimension of the current video block.

11. The method of any of solutions 1 to 3, wherein a number of the one or more non-adjacent neighboring blocks is based on coordinates of the current video block.

12. A method of video processing, comprising inserting, for a conversion between a current video block of a video and a bitstream of the video, one or more block vectors corresponding to one or more non-adjacent neighboring blocks of the current video block into a list of motion candidates for the current video block, wherein the inserting is based on an availability of block vectors from (i) a list of history-based block vector prediction (HBVP) candidates or (ii) adjacent neighboring blocks of the current video block; and performing, based on the list of motion candidates, the conversion.

13. The method of solution 12, wherein the list comprises an intra block copy (IBC) merge list.

14. The method of solution 12, wherein the list comprises an intra block copy (IBC) advanced motion vector prediction (AMVP) list.

15. The method of any of solutions 12 to 14, wherein the one or more block vectors corresponding to the one or more non-adjacent neighboring blocks are inserted into the list of motion candidates after the block vectors from the list of HBVP candidates.

16. The method of any of solutions 12 to 14, wherein the one or more block vectors corresponding to the one or more non-adjacent neighboring blocks are not inserted into the list of motion candidates in response to the list of motion candidates comprising no empty entries after inserting the block vectors from (i) the list of HBVP candidates or (ii) the adjacent neighboring blocks of the current video block.

17. The method of any of solutions 12 to 14, wherein the one or more block vectors corresponding to the one or more non-adjacent neighboring blocks are inserted into the list of motion candidates before the block vectors from the list of HBVP candidates.

18. The method of any of solutions 12 to 14, wherein the one or more block vectors corresponding to the one or more non-adjacent neighboring blocks are interleaved with the block vectors from the list of HBVP candidates for insertion into the list of motion candidates.

19. The method of any of solutions 12 to 14, wherein the one or more block vectors corresponding to the one or more non-adjacent neighboring blocks are inserted into the list of motion candidates after the block vectors from the adjacent neighboring blocks.

20. The method of any of solutions 12 to 14, wherein the one or more block vectors corresponding to the one or more non-adjacent neighboring blocks are inserted into the list of motion candidates before the block vectors from the adjacent neighboring blocks.

21. The method of any of solutions 12 to 14, wherein the one or more block vectors corresponding to the one or more non-adjacent neighboring blocks are interleaved with the block vectors from the adjacent neighboring blocks for insertion into the list of motion candidates.

22. The method of any of solutions 12 to 14, further comprising classifying the one or more block vectors corresponding to the one or more non-adjacent neighboring blocks of the current video block into N classes, wherein N is a non-negative integer, and wherein the block vectors from the list of HBVP candidates have been classified into the N classes.

23. The method of solution 22, wherein N=5, and wherein the classifying is based on a relative position of a neighboring block to the current video block.

24. The method of solution 23, wherein the N classes comprise an above-left class, an above-right class, a below-left class, an above class, and a left class.

25. The method of solution 22, wherein the N classes are based a block size associated with the block vectors (denoted BvBlkSize) and a size of the current video block (denoted CurBlkSize).

26. The method of solution 25, wherein the BvBlkSize is greater than or equal to factor×CurBlkSize, and wherein factor is a non-negative integer.

27. The method of solution 26, wherein factor=1.

28. A method of video processing, comprising determining, for a conversion between a current video block of a video and a bitstream of the video, that a range of a block vector component in a one-dimensional block vector search is based on a property of the current video block; and performing, based on the determining, the conversion.

29. The method of solution 28, wherein the property comprises a coordinate of the current video block, and wherein the property is sufficient to determine the range.

30. The method of solution 28, wherein the property is different from a dimension of the current video block.

31. The method of solution 28, wherein the block vector (BV) component is a vertical BV component and the one-dimensional BV search is a one-dimensional vertical BV search, wherein the vertical BV component is constrained to be less than or equal to y−N1, and wherein N1 is an integer.

32. The method of solution 31, wherein N1=−8, 0, or 8.

33. The method of any of solutions 1 to 32, wherein the conversion comprises decoding the current video block from the bitstream.

34. The method of any of solutions 1 to 32, wherein the conversion comprises encoding the current video block into the bitstream.

35. A method of storing a bitstream representing a video to a computer-readable recording medium, comprising generating the bitstream from the video according to a method described in any one or more of solutions 1 to 32; and storing the bitstream in the computer-readable recording medium.

36. A video processing apparatus comprising a processor configured to implement a method recited in any one or more of solutions 1 to 35.

37. A computer-readable medium having instructions stored thereon, the instructions, when executed, causing a processor to implement a method recited in one or more of solutions 1 to 35.

38. A computer readable medium that stores the bitstream generated according to any one or more of solutions 1 to 35.

39. A video processing apparatus for storing a bitstream, wherein the video processing apparatus is configured to implement a method recited in any one or more of solutions 1 to 35.

Another listing of solutions preferred by some embodiments is provided next.

P1. A video processing method, comprising constructing, for a conversion between a video block of a video and a coded representation of the video, a list of motion candidates by adding one or more block vectors corresponding to one or more non-adjacent blocks of the current video block according to a rule, and performing the conversion based on the list of motion candidates.

P2. The method of solution P1, wherein the list includes an intra block copy merge list.

P3. The method of any of solutions P1 to P2, wherein the list includes an advanced motion vector predictor list.

P4. The method of any of solutions P1 to P3, wherein the rule specifies an order in which the one or more non-adjacent blocks are checked for motion candidates based on positions of the one or more non-adjacent neighboring blocks relative to the current video block.

P5. The method of solution P4, wherein the order comprises first checking an above-left neighboring block, then an above-right neighboring block, then an below-left neighboring block, then an above neighboring block, and the left neighboring block of the current block.

P6. The method of solution P4, wherein the order comprises: left neighboring block, above neighboring block, above-left neighboring block, above-right neighboring block and below-left neighboring block of the current block.

P7. A method of video processing, comprising determining, for a conversion between a current video block of a video and a bitstream representation of the video, whether a condition under which block vectors of one or more block vectors of one or more non-adjacent neighboring blocks is met, wherein the condition depends on availability of a block vector from a history based block vector prediction list or availability of block vectors of an adjacent neighboring block; and performing the conversion according to the determining.

P8. The method of solution P7, wherein the condition for adding the block vectors of the one or more non-adjacent neighboring blocks is that all history based block vectors are inserted in the list.

P9. A video processing method, comprising determining, for a conversion between a current video block of a video and a coded representation of the video, whether a block vector in a history based block vector predictor (HBVP) list is classified into Nth class according to a rule that depends on a block size associated with the block vector or a size of the current video block; and performing the conversion based on the determining.

P10. The method of solution P9, wherein the rule specifies to classify the block vector in case that the block size associated with the block vector is a factor multiple of the size of the current video block.

P11. The method of solution P10, wherein the factor is equal to 1.

P12. A method of video processing, comprising determining, for a conversion between a current video block of a video and a coded representation of the video, a one-dimensional search range for determination of a block vector based on a rule based on a property of the current video block; and performing the conversion according to the determining.

P13. The method of solution P12, wherein the property comprises a coordinate of the current video block and wherein the property is sufficient to determine the search range.

P14. The method of solution P12, wherein the property comprises a size of the current video block.

P15. The method of any of solutions P1 to P14, wherein the performing the conversion comprises encoding the video to generate the coded representation.

P16. The method of any of solutions P1 to P14, wherein the performing the conversion comprises parsing and decoding the coded representation to generate the video.

P17. A video decoding apparatus comprising a processor configured to implement a method recited in one or more of solutions P1 to P16.

P18. A video encoding apparatus comprising a processor configured to implement a method recited in one or more of solutions P1 to P16.

P19. A computer program product having computer code stored thereon, the code, when executed by a processor, causes the processor to implement a method recited in any of solutions P1 to P16.

In the present document, the term “video processing” may refer to video encoding, video decoding, video compression or video decompression. For example, video compression algorithms may be applied during conversion from pixel representation of a video to a corresponding bitstream representation or vice versa. The bitstream representation (or simply, the bitstream) of a current video block may, for example, correspond to bits that are either co-located or spread in different places within the bitstream, as is defined by the syntax. For example, a macroblock may be encoded in terms of transformed and coded error residual values and also using bits in headers and other fields in the bitstream.

The disclosed and other solutions, examples, embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of any subject matter or of what may be claimed, but rather as descriptions of features that may be specific to particular embodiments of particular techniques. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A method of video processing, comprising:
inserting, for a conversion between a current video block of a video and a bitstream of the video, one or more block vectors corresponding to one or more non-adjacent neighboring blocks of the current video block into a list of motion candidates for the current video block, wherein the inserting is based on a rule that specifies the one or more non-adjacent neighboring blocks are checked; and
performing, based on the list of motion candidates, the conversion.

2. The method of claim 1, wherein the list comprises an intra block copy (IBC) merge list.

3. The method of claim 1, wherein the list comprises an intra block copy (IBC) advanced motion vector prediction (AMVP) list.

4. The method of claim 1, wherein positions of the one or more non-adjacent neighboring blocks relative to the current video block are based on a width (W) and a height (H) of the current video block.

5. The method of claim 4, wherein the one or more non-adjacent neighboring blocks that cover positions (x−M, y+H/2) or (x+W/2, y−M) are checked when constructing the list of motion candidates, wherein a coordinator of a top-left sample of the current video block is (x, y), M is an integer.

6. The method of claim 5, wherein M=8.

7. The method of claim 1, wherein the rule specifies that the one or more block vectors corresponding to the one or more non-adjacent neighboring blocks are inserted into the list of motion candidates after the block vectors from a history-based block vector prediction (HBVP) candidates list.

8. The method of claim 1, wherein the rule specifies that the one or more block vectors corresponding to the one or more non-adjacent neighboring blocks are not inserted into the list of motion candidates in response to the list of motion candidates comprising no empty entries after inserting the block vectors from (i) a history-based block vector prediction (HBVP) candidates list and/or (ii) adjacent neighboring blocks of the current video block.

9. The method of claim 1, wherein the conversion comprises decoding the current video block from the bitstream.

10. The method of claim 1, wherein the conversion comprises encoding the current video block into the bitstream.

11. An apparatus for processing video data comprising a processor and a non-transitory memory with instructions thereon, wherein the instructions upon execution by the processor, cause the processor to:
insert, for a conversion between a current video block of a video and a bitstream of the video, one or more block vectors corresponding to one or more non-adjacent neighboring blocks of the current video block into a list of motion candidates for the current video block, wherein the inserting is based on a rule that specifies the one or more non-adjacent neighboring blocks are checked; and
perform, based on the list of motion candidates, the conversion.

12. The apparatus of claim 11, wherein the list comprises an intra block copy (IBC) merge list or an intra block copy (IBC) advanced motion vector prediction (AMVP) list.

13. The apparatus of claim 11, wherein positions of the one or more non-adjacent neighboring blocks relative to the current video block are based on a width (W) and a height (H) of the current video block,
wherein the one or more non-adjacent neighboring blocks that cover positions (x−M, y+H/2) or (x+W/2, y−M) are checked when constructing the list of motion candidates, wherein a coordinator of a top-left sample of the current video block is (x, y), M=8.

14. The apparatus of claim 11, wherein the rule specifies that the one or more block vectors corresponding to the one or more non-adjacent neighboring blocks are inserted into the list of motion candidates after the block vectors from a history-based block vector prediction (HBVP) candidates list.

15. The apparatus of claim 11, wherein the rule specifies that the one or more block vectors corresponding to the one or more non-adjacent neighboring blocks are not inserted into the list of motion candidates in response to the list of motion candidates comprising no empty entries after inserting the block vectors from (i) a history-based block vector prediction (HBVP) candidates list and/or (ii) adjacent neighboring blocks of the current video block.

16. A non-transitory computer-readable storage medium storing instructions that cause a processor to:
insert, for a conversion between a current video block of a video and a bitstream of the video, one or more block vectors corresponding to one or more non-adjacent neighboring blocks of the current video block into a list of motion candidates for the current video block, wherein the inserting is based on a rule that specifies the one or more non-adjacent neighboring blocks are checked; and
perform, based on the list of motion candidates, the conversion.

17. The non-transitory computer-readable storage medium of claim 16, wherein the list comprises an intra block copy (IBC) merge list or an intra block copy (IBC) advanced motion vector prediction (AMVP) list,
wherein positions of the one or more non-adjacent neighboring blocks relative to the current video block are based on a width (W) and a height (H) of the current video block,
wherein the one or more non-adjacent neighboring blocks that cover positions (x−M, y+H/2) or (x+W/2, y−M) are checked when constructing the list of motion candidates, wherein a coordinator of a top-left sample of the current video block is (x, y), M=8,
wherein the rule specifies that the one or more block vectors corresponding to the one or more non-adjacent neighboring blocks are inserted into the list of motion candidates after the block vectors from a history-based block vector prediction (HBVP) candidates list, and
wherein the rule specifies that the one or more block vectors corresponding to the one or more non-adjacent neighboring blocks are not inserted into the list of motion candidates in response to the list of motion candidates comprising no empty entries after inserting the block vectors from (i) a history-based block vector prediction (HBVP) candidates list and/or (ii) adjacent neighboring blocks of the current video block.

18. A non-transitory computer-readable recording medium storing a bitstream of a video which is generated by a method performed by a video processing apparatus, wherein the method comprises:
inserting one or more block vectors corresponding to one or more non-adjacent neighboring blocks of a current video block of the video into a list of motion candidates for the current video block, wherein the inserting is based on a rule that specifies the one or more non-adjacent neighboring blocks are checked; and
generating the bitstream based on the list of motion candidates.

19. The non-transitory computer-readable recording medium of claim 18, wherein the list comprises an intra block copy (IBC) merge list or an intra block copy (IBC) advanced motion vector prediction (AMVP) list,
wherein positions of the one or more non-adjacent neighboring blocks relative to the current video block are based on a width (W) and a height (H) of the current video block,
wherein the one or more non-adjacent neighboring blocks that cover positions (x−M, y+H/2) or (x+W/2, y−M) are checked when constructing the list of motion candidates, wherein a coordinator of a top-left sample of the current video block is (x, y), M=8.

20. The non-transitory computer-readable recording medium of claim 18, wherein the rule specifies that the one or more block vectors corresponding to the one or more non-adjacent neighboring blocks are inserted into the list of motion candidates after the block vectors from a history-based block vector prediction (HBVP) candidates list, and
wherein the rule specifies that the one or more block vectors corresponding to the one or more non-adjacent neighboring blocks are not inserted into the list of motion candidates in response to the list of motion candidates comprising no empty entries after inserting the block vectors from (i) a history-based block vector prediction (HBVP) candidates list and/or (ii) adjacent neighboring blocks of the current video block.
